(19) United States
(12) Patent Application Publication
(10) Pub. No.: US 2014/0259871 A1
(43) Pub. Date: Sep. 18, 2014

(54) FISHING HOOK GUARD AND GUARD-EQUIPPED FISHING HOOK HAVING THE GUARD ATTACHED THERETO

(71) Applicant: Kazunori Sano, Nishiwaki-Shi (JP)

(72) Inventor: Kazunori Sano, Nishiwaki-Shi (JP)

(73) Assignee: GAMAKATSU CO., LTD., Nishiwaki-shi, Hyogo (JP)

(21) Appl. No.: 14/357,480

(22) PCT Filed: Nov. 10, 2011
(86) PCT No.: PCT/JP2011/006297

§ 371 Date: Jun. 2, 2014

(51) Int. Cl. A01K 83/00

(52) U.S. Cl. CPC A01K 83/00
USPC 43/43.2

(57) ABSTRACT

A fishing hook guard is provided which not only is able to prevent a guard member from being broken but also allows the direction of the guard member to be easily adjusted, and further allows the guard member to be easily replaced. It is possible to attain the above object when a fishing hook guard 10 includes a guard member 14 having flexibility and a base 16 formed from an elastic material and including: a shank insertion hole 18 through which a shank 12b of a fishing hook 12 is inserted and which has a smaller diameter than that of the shank 12b; and a guard member holding portion 20 which holds one end portion 14a of the guard member 14 such that another end portion 14b of the guard member 14 is directed toward a leading end portion 12a of the fishing hook 12.

### TECHNICAL FIELD

The present invention relates to a fishing hook guard which prevents a fishing hook from being caught in something and waterweed or floating matter from being undesirably caught by the fishing hook; and a guard-equipped fishing hook having the guard attached thereto.

### BACKGROUND ART

Basically, a fishing hook on which a bait is put is placed as close to fish as possible in order to improve a fishing result. In general, fish often hides near an obstacle in water or floating matter on the surface of water. Thus, an attempt is made to place a fishing hook near fish, so that the fishing hook is often caught in an obstacle or floating matter, which results in a fishing device being lost or which scares the fish away.

In order to handle such a problem, a fishing hook guard 1 as shown in FIG. 11 has been developed. The fishing hook guard 1 is formed from a nylon wire having flexibility and includes: a guard member 2 one end portion 2a of which is bent at a predetermined angle; and a binding thread 4 which ties and secures a fishing hook 3 and the one end portion 2a of the guard member 2 together in a state where the one end portion 2a of the guard member 2 is held to a shank 3a of the fishing hook 3.

When such a fishing hook guard 1 is attached to the shank 3a of the fishing hook 3 such that another end portion 2b of the guard member 2 is located above a leading end portion 3b of the fishing hook 3, an obstacle or floating matter comes into contact with the guard member 2 earlier than is caught by the leading end portion 3b of the fishing hook 3, and thus it is possible to avoid the fishing hook 3 from being caught in the obstacle or floating matter.

In addition, a fishing hook guard disclosed in Patent Literature 1 is obtained by modifying the above-described fishing hook guard, and a bent portion between one end portion of a guard member attached to a shank of a fishing hook and another end portion of the guard member extending toward a leading end portion of the fishing hook is formed in a coil shape. Thus, even when an excessive force is repeatedly applied to an end of the guard member at the fishing hook side, it is possible to prevent the guard member from being broken due to fatigue or the like.

### CITATION LIST

### Patent Literature

[PTL 1] Japanese Laid-Open Patent Publication No. 2003-70381

### SUMMARY OF THE INVENTION

### Problems to be Solved by the Invention

However, in the above-described conventional fishing hook guard 1, since it is necessary to secure the guard member 2 to the shank 3a of the fishing hook 3 by using the binding thread 4, it is difficult to secure the guard member 2 such that another end portion 2b of the guard member 2 is accurately directed toward the leading end portion 3b of the fishing hook 3. In addition, there is the problem that even when the guard member 2 is attached in an appropriate direction, the direction of the guard member 2 is likely to be changed during use.

Furthermore, it is ideal to adjust the magnitude of the flexibility of the guard member 2 by changing the diameter and/or material of the guard member 2 of the fishing hook guard 1 in accordance with the amount of obstacles or floating matter at a fishing spot or the types of them. However, in the conventional example, since the guard member 2 is secured to the fishing hook 3 by using the binding thread 4, there is the problem that it takes very much time and effort to replace the guard member 2.

The present invention has been made in view of such problems of the conventional art. Therefore, a main object of the present invention is to provide a fishing hook guard which not only is able to prevent a guard member from being broken but also allows the direction of the guard member to be easily adjusted, and further allows the guard member to be easily replaced; and a fishing hook using the same.

### Solution to the Problems

In order to attain the above-described object, according to the present invention, as shown in FIG. 1 or 10, a fishing hook guard 10 includes:

a guard member 14 having flexibility; and

a base 16 formed from an elastic material and including: a shank insertion hole 18 through which a shank 12b of a fishing hook 12 is inserted and which has a smaller diameter than that of the shank 12b; and a guard member holding portion 20 which holds one end portion 14a of the guard member 14 such that another end portion 14b of the guard member 14 is directed toward a leading end portion 12a of the fishing hook 12.

The fishing hook guard 10 according to the present invention is allowed to be attached at a predetermined position by: attaching the one end portion 14a of the guard member 14 to the guard member holding portion 20 of the base 16 such that the other end portion 14b of the guard member 14 is directed toward the leading end portion 12a of the fishing hook 12; and inserting the shank 12b of the fishing hook 12 through the shank insertion hole 18. Since the one end portion 14a of the guard member 14 is attached to the base 16 having elasticity, even when an excessive force is repeatedly applied to the guard member 14, the base 16 deforms due to its elasticity in addition to the flexibility of the guard member 14, and thus the guard member 14 is not broken due to fatigue or the like.

In addition, since the shank insertion hole 18 of the base 16 is formed so as to have a smaller diameter than that of the shank 12b of the fishing hook 12, when the shank 12b of the fishing hook 12 is inserted through the shank insertion hole 18, the base 16 always tightens the shank 12b due to its elasticity, and the, position of the base 16 is fixed by the tightening force. However, since the fishing hook 12 and the base 16 are not secured to each other by an adhesive or the like, it is possible to easily adjust the position and the direction of the base 16 at the shank 12b of the fishing hook 12 by applying to the base 16 a greater force than the tightening force.

Furthermore, since it is easy to detach the base 16 from the fishing hook 12, it is possible to easily replace the guard member 14 according to need.

It should be noted that, as is obvious from the role of the fishing hook guard 10, “flexibility” means such a degree: that when the fishing hook guard 10 comes into contact with an obstacle or floating matter, the fishing hook guard 10 almost does not bend and is able to avoid the fishing hook 12 from being caught in the obstacle or the like; and that when a fish attempts to bite the fishing hook 12, the fishing hook guard 10 bends and the fishing hook 12 is caught in the mouth of the fish, The same applies to the entirety of the present specification.

The following configuration is preferably added to the present invention, Specifically,

the guard member holding portion 20 of the base 16 is a through hole, and

the guard member 14 is formed by bending a single wire-like material, a bent portion of the guard member 14 is the one end portion 14a which is held by the base 16, and the guard member 14 is disposed so as to straddle the shank insertion hole 18 by inserting the guard member 14 through the guard member holding portion 20.

According to this, since the guard member 14 is attached to the guard member holding portion 20 so as to straddle the shank insertion hole 18 as shown in FIG. 5, when the fishing hook 12 is inserted through the shank insertion hole 18 and the base 16 is disposed at a predetermined position on the shank 12b, the bent portion (=one end portion 14a) of the guard member 14 is hooked on the shank 12b of the fishing hook 12 and cannot he pulled out.

In addition, also when a center portion in a width direction at other openings 26 in the guard member holding portion 20 is not opened as shown in FIG. 8, it is the same in that the bent portion (=one end portion 14a) of the guard member 14 cannot be pulled out.

Furthermore, as shown in FIG. 9, the guard member holding portion 20 can be composed of two through holes between which the shank insertion hole 18 is located, and a center portion in the width direction at one opening 24 can also he in a state of being not opened, in addition to the other openings 26. In this case as well, the bent portion one end portion 14a) of the guard member 14 cannot be pulled out.

Therefore, in addition to the above-described advantageous effects, an adhesive or the like is unnecessary for attaching the guard member 14 to the base 16, and it is made further easy to attach the fishing hook guard 10, adjust the position of the fishing hook guard 10, and replace the guard member 14.

In addition, the following configuration is preferably added, Specifically, the guard member holding portion 20 is a through hole which traverses the shank insertion hole 18 and is wider than the shank 12b of the fishing hook 12.

When the guard member holding portion 20 is a through hole which traverses the shank insertion hole 18 and is wider than the shank 12b of the fishing hook 12, it is possible to hook the one end portion 14a of the guard member 14 directly on the shank 12b of the fishing hook 12 as shown in FIG. 5, and thus it is possible to firmly attach the guard member 14 to the fishing hook 12 unlike the case where the base 16 having elasticity is interposed between the guard member 14 and the shank 12b.

Furthermore, the following configuration is preferably added. Specifically; a cross-sectional shape of the guard member holding portion 20 in a width direction which is orthogonal to the shank insertion hole 18 is symmetrical about a central axis CL of the shank insertion hole 18.

Thus, in a state where the fishing hook guard 10 is attached to the fishing hook 12, the guard member 14 which is bent into two portions is provided such that the two portions are arranged equally with respect to the shank 12b inserted through the shank insertion hole 18, as a center in the width direction thereof, and thus it is possible to improve the appearance of the fishing hook guard 10 in a state of being attached to the fishing hook 12.

In addition, as a matter of course, a guard-equipped fishing hook having the fishing hook guard 10 according to the present invention attached thereto can attain the above-described object.

### Advantageous Effects of the Invention

According to the present invention, a fishing hook guard which not only is able to prevent a guard member from being broken but also allows the direction of the guard member to be easily adjusted, and further allows the guard member to be easily replaced; and a guard-equipped fishing hook using the same, are provided.

### BRIEF DESCRIPTION OF THE DRAWINGS

FIG. 1 is a front view of a guard-equipped fishing hook to which the present invention is applied.

[FIG. 2] (a) is a front view of a base constituting a fishing hook guard, (h) is a. plan view of the base, (c) is an A-A cross-sectional view of the base, and (d) is a B-B cross-sectional view of the base.

FIG. 3 is a front view illustrating another embodiment regarding the shape of a guard member holding portion formed in the base.

FIG. 4 is a diagram for explaining a procedure of manufacturing the base.

FIG. 5 is a cross-sectional view for explaining a procedure of attaching the fishing hook guard.

FIG. 6 is a cross-sectional view for explaining the procedure of attaching the fishing hook guard,

FIG. 7 is a front view illustrating another embodiment.

FIG. 8 is a cross-sectional view illustrating another embodiment.

FIG. 9 is a cross-sectional view illustrating another embodiment.

FIG. 10 is a cross-sectional view illustrating another embodiment.

FIG. 11 is a diagram illustrating conventional art.

### DESCRIPTION OF EMBODIMENTS

Hereinafter, embodiments of the present invention will be described with reference to the drawings. FIG. 1 is a diagram showing a state where a fishing hook guard 10 according to the present invention is attached to an arbitrary fishing hook 12. The fishing hook guard 10 includes a guard member 14 and a base 16.

The guard member 14 is a member formed from a material having flexibility, and nylon is used as the material in the present embodiment. However, the material is not limited to synthetic fibers/resins such as nylon, and wire-like materials of metals such as nickel and titanium can be used since they have flexibility.

In the present embodiment, the guard member 14 is formed by bending a single wire-like material at its center portion. As described later, the bent portion of the guard member 14 is one end portion 14a which is fitted into the base 16, and end portions thereof opposite to the one end portion 14a (other end portions 14b) are located above a leading end portion 12a of the fishing hook 12 (since the single wire-like material is bent, the other end portions 14b are present at two locations). As a matter of course, a plurality of guard members 14 may be used for the one fishing hook guard 10.

In addition, regarding the diameters of wire-like materials used for the guard member 14, in the case of nylon, wire-like materials having diameters that are between 0.3 mm and 0.6 mm and at intervals of 0.1 mm are preferably prepared; and in the case of wire-like materials of metals such as nickel and titanium, wire-like materials having diameters that are between 0.1 mm and 0.3 mm and at intervals of 0.1 mm are preferably prepared.

The base 16 is formed from an elastic material, and includes a shank insertion hole 18 and a guard member holding portion 20 as shown in FIG. 2. As the elastic material forming the base 16, an elastomer, butyl rubber, flexible polyurethane, or another material can be used, as long as a shank 12b of the fishing hook 12 which has a larger diameter than that of the shank insertion hole 18 is allowed to be inserted through the shank insertion hole 18; and the shank 12b is allowed to be tightened by an elastic restoring force thereof to maintain the position of the base 16 after positioning of the shank 12b. It should be noted that in the case where the guard member 14 is secured to the base 16 by an instantaneous adhesive, it is preferred to avoid use of silicon, on which the instantaneous adhesive has difficulty in working, as the material of the base 16.

In addition, an upper portion of the base 16 (an end portion close to an eye of the fishing hook 12 When being attached to the fishing hook 12) is formed in a substantially hemispherical shape, and a lower portion thereof is formed in a tapered shape. Since the upper portion is formed in a substantially hemispherical shape, water resistance applied when the fishing hook 12 is pulled up from water is reduced. Moreover, since the lower portion is formed in a tapered shape, the base 16 is less likely to slip down on the shank 12b of the fishing hook 12.

The shank insertion hole 18 is formed so as to have a smaller diameter than that of the shank 12b of the fishing hook 12 and so as to extend through the base 16 in an up-down direction. It should be noted that the cross-sectional shape of the shank insertion hole 18 is not limited to a circular shape as shown and may be a square shape. In addition, the diameter dimension of the shank insertion hole 18 is determined in accordance with the diameter dimension of the shank 12b of the fishing hook 12 to be used, the elastic modulus of the elastic material forming the base 16, and the like.

The guard member holding portion 20 is a through hole which extends through the base 16 in a right-left direction and holds the one end portion 14a of the guard member 14 such that the other end portions 14b of the guard member 14 are directed toward the leading end portion 12a of the fishing hook 12. In addition, the guard member holding portion 20 is formed so as to traverse the shank insertion hole 18 and so as to be wider than the shank. 12b of the fishing hook 12. The cross-sectional shape of the guard member holding portion 20 is not limited to a laterally long rectangular shape as shown and may be an elliptical shape ((a) of FIG. 3) or a rhombic shape ((h) of FIG. 3) as shown in FIG. 3, but the cross-sectional shape of the guard member holding portion 20 in a width direction which is orthogonal to the shank insertion hole 18 is preferably symmetrical about a central axis CL of the shank insertion hole 18. When the guard member holding portion 20 is symmetrically formed as described above, the guard member 14 which is bent into two portions is provided such that the two portions are arranged equally with respect to the shank 12b inserted through the shank insertion hole 18, as a center in the width direction thereof, and thus it is possible to improve the appearance of the fishing hook guard 10 in a state of being attached to the fishing hook 12.

A procedure of manufacturing such a fishing hook guard 10 and a procedure of attaching such a fishing hook guard 10 to the fishing hook 12 will be described.

The base 16 of the fishing hook guard 10 is manufactured by injection molding. As shown in FIG. 4, cores 22 are previously placed at positions within a cavity having the same shape as the outer shape of the base 16 at which positions the shank insertion hole 18 and the guard member holding portion 20 are to be formed, and the elastic material is injected. Thereafter, the cores 22 are removed to complete the base 16. As a matter of course, the core 22 may be used only for forming the guard member holding portion 20, and the shank insertion hole 18 may be independently formed by using a drill, an awl, or the like.

After the base 16 is formed, as shown in FIG. 5, the guard member 14 which is formed by bending the single wire-like material at its center portion is fitted at its one end portion 14a bent portion) into the guard member holding portion 20 of the base 16. At that time, it is necessary to fit the one end portion 14a to such a position that the guard member 14 straddles the shank insertion hole 18.

Thereafter, the fishing hook 12 is inserted through the shank insertion hole 18, and the base 16 (and the guard member 14) is moved to a desired position on the shank 12b of the fishing hook 12. Finally, as shown in FIG. 6, the guard member 14 is pulled toward the side of the leading end portion 12a of the fishing hook 12 such that the one end portion 14a bent portion) is hooked on the shank 12b of the fishing hook 12, thereby completing the attachment of the fishing hook guard 10 to the fishing hook 12. By so doing, the one end portion 14a bent portion) of the guard member 14 is hooked on the shank 12b of the fishing hook 12 and cannot be pulled out further.

The fishing hook guard 10 of the present embodiment is allowed to be attached at a predetermined position by fitting the one end portion 14a (=bent portion) of the guard member 14 into the guard member holding portion 20 of the base 16 and inserting the shank 12b of the fishing, hook 12 through the shank insertion hole 18. Since the one end portion 14a of the guard member 14 is attached to the base 16 having elasticity, even when an excessive force is repeatedly applied to the guard member 14, the base 16 deforms due to its elasticity in addition to the flexibility of the guard member 14, and thus the guard member is not broken due to fatigue or the like.

In addition, since the shank insertion hole 18 of the base 16 is formed so as to have a smaller diameter than that of the shank 12b of the fishing hook 12, when the shank 12b of the fishing hook 12 is inserted through the shank insertion hole 18, the base 16 always tightens the shank 12b due to its elasticity, arid the position of the base 16 is fixed by the tightening force, However, since the fishing hook 12 and the base 16 are not secured to each other by an adhesive or the like, it is possible to easily adjust the position and the direction of the base 16 at the shank 12b of the fishing hook 12 by applying to the base 16 a greater force than the tightening force.

Furthermore, since the guard member 14 is merely fitted into the guard member holding portion 20 of the base 16, when it is necessary to replace the guard member 14, the fishing hook 12 is pulled out from the base 16, the old guard member 14 is pulled out from the guard member holding portion 20, a new guard member 14 is fitted into the guard member holding portion 20, and the fishing hook 12 is inserted through the shank insertion hole 18 of the base 16 again as described above, whereby it is possible to easily replace the guard member 14.

Moreover, since an adhesive or the like is unnecessary for attaching the fishing hook guard 10, it is possible to easily perform attachment of and adjustment of the position of the fishing hook guard 10 and further replacement of the guard member 14.

It should be noted that in the above-described embodiment, the guard member holding portion 20 of the base 16 is formed at such an angle as to be substantially orthogonal to the shank insertion hole 18, and the guard member 14 extends at such an angle as to be orthogonal to the shank 12b of the fishing hook 12 (see FIG. 1), but the angle of the guard member holding portion 20 relative to the shank insertion hole 18 is not limited to this, and, for example, as shown in FIG. 7, the guard member holding portion 20 may be formed at an acute angle θ relative to the shank insertion hole 18 such that the guard member 14 thrills an acute angle θ relative to the shank 12b of the fishing hook 12. This is effective when the other end portions 14b of the guard member 14 are desired to be closer to the leading end portion 12a of the fishing hook 12.

In addition, as a modification of the guard member holding portion 20, as shown in FIG. 8, the guard member holding portion 20 may be formed in a substantially U shape in a cross-sectional view, may be opened up to the shank insertion hole 18 over the entirety of the guard member holding portion 20 in its width direction when being seen from one opening 24 of the guard member holding portion 20, but the guard member holding portion 20 may be not opened at its center portion of the guard member holding portion 20 in the width direction and may be opened only at both end portions thereof in the width direction when being seen from other openings 26. According to this during manufacture of the base 16, it is unnecessary to use the two-piece core 22 as in the above-described embodiment, and it is only necessary to use one substantially U-shaped core 22 as shown in (a) of FIG. 8. Thus, it is possible to more easily manufacture the base 16. In FIG. 8, (b) shows a state where the guard member 14 is attached to a modification of the base 16. In this case, the other end portions 14b of the guard member 14 are inserted through the respective other openings 26 of the base 16, and the one end portion 14a of the guard member 14 is brought into contact with and stopped at the center portion at the other openings 26.

Moreover, in a modification of the guard member holding portion 20 shown in FIG. 9, the guard member holding portion 20 is composed of two through holes, between which the shank insertion hole 18 is located, such that in addition to the other openings 26, a center portion in the width direction at the one opening 24 is not opened. In this case as well, the other end portions 14b of the guard member 14 are inserted through the respective other openings 26 of the base 16, and the one end portion 14a of the guard member 14 is brought into contact with and stopped at the center portion at the other openings 26.

Furthermore, as another embodiment, as shown in FIG. 10, an example is also conceivable in which the guard member holding portion 20 is not formed as a through hole. In this case, a wire-like material is used as the guard member 14 as it is without being bent, and the one end portion 14a of the wire-like guard member 14 is inserted and installed into the guard member holding portion 20. However, in this embodiment, it is necessary to secure the guard member 14 and the base 16 to each other by an instantaneous adhesive or the like, and thus there is the possibility that it takes time and effort to some extent to attach the fishing hook guard 10, adjust the position of the fishing hook guard 10, and replace the guard member 14 as compared to the above-described embodiment.

### DESCRIPTION OF THE REFERENCE CHARACTERS

10 fishing hook guard

12 fishing hook

12a leading end portion (of fishing hook)

12b shank (of fishing hook)

14 guard member

14a one end portion (of guard member) 14b another end portion (of guard member)

16 base

18 shank insertion hole

20 guard member holding portion

22 core

24 one opening

26 another opening

1. A fishing hook guard comprising:
a guard member having flexibility; and
a base formed from an elastic material, the base having a shank insertion hole through which a shank of a fishing hook is inserted and which has a smaller diameter than that of the shank; and a guard member holding portion which holds one end portion of the guard member such that another end portion of the guard member is directed toward a leading end portion of the fishing hook, wherein the guard member holding portion of the base is a through hole, and the guard member is formed by bending a single wire-like material, a bent portion of the guard member is the one end portion which is held by the base, and the guard member is disposed so as to straddle the shank insertion hole by inserting the guard member through the guard member holding portion.

2. (canceled)

3. The fishing hook guard according to claim 1, wherein the guard member holding portion is a through hole which traverses the shank insertion hole and is wider than the shank of the fishing hook.

4. The fishing hook guard according to claim 3, wherein a cross-sectional shape of the guard member holding portion in a width direction which is orthogonal to the shank insertion hole is symmetrical about a central axis of the shank insertion hole.

5. A guard-equipped fishing hook having the fishing hook guard attached thereto according to claim 1.
